(19) United States
(12) Patent Application Publication
(10) Pub. No.: US 2006/0268346 A1
(43) Pub. Date: Nov. 30, 2006

(54) Method and apparatus for elimination of ghosting or reverse side reflection in a scanned document

(75) Inventor: Ron van Os, Morrison, CO (US)

Correspondence Address: Diane van Os, 8016 South Deer Creek Canyon Road, Morrison, CO, 80465, US

(73) Assignee: Visioneer, Inc. a wholly owned subsidiary of Soque Holdings, Ltd.

(21) Appl. No.: 11/140,653

(22) Filed: May 27, 2005

(51) Int. Cl. H04N 1/60

(52) U.S. Cl. 358/3.26; 358/1.9; 358/406

(57) ABSTRACT

The invention claimed is a method for elimination of a reverse side reflection, or ghosting effect, resulting from a dual sided media being scanned utilizing a standard document scanner or analogous hardware wherein the reverse side reflection typically results in a defect on the scanned image. The inventive method is unique to the prior art in that it incorporates backing which impedes reflection of the reverse side of a scanned page that typically manifests as an unwanted artifact on the resultant scanned image. The inventive method further eliminates, in the case of sheet fed or duplex scanners, the requirement for alternating the scanner's light source to create artificial black and white reference for calibration of the scanner.

### FIELD

The invention relates to an apparatus and method for eliminating ghosting, or reverse side reflection of an image wherein a double-sided medium is scanned. In the present invention, whether the scanner be a sheet fed, flat bed, or duplex scanner, the ghosting may be eliminated by utilizing appropriate background colors on the inventive apparatus to effect an accurate calibration and scan. The inventive method utilizes a black background as optimum for eliminating reflection of a dual sided medium. In present methods, such a background alone would interfere with the ability to calibrate a scanner, and, as a result, current scanners utilize white or light colored backing coupled with alternating the light source to effect calibration. In the inventive method, the scanner backing may be black to avoid reflection and eliminate ghosting in a flatbed configuration, while a component of dual black and white colors is introduced into the mechanics of a sheet fed scanner to eliminate ghosting and allow for simpler calibration of the scanner.

### BACKGROUND OF THE INVENTION

The invention most closely corresponds with USPTO Class 358/275, wherein the invention involves the communication or reproduction of a static image or sequence of static images in which the density variations composing the image do not vary with time (e.g., a document image) by a method or apparatus. Corresponding to subclass 275, the invention involves correcting undesirable image characteristics such as spatial distortion (i.e., subtracting difference data between frames to correct for blurring due to motion), sensor or optical system induced artifacts (i.e., geometric aberrations), process induced artifacts (i.e., “worm” artifacts caused by error diffusion), or physical deterioration of a scanned object itself (i.e., dirt or dust on photographic negatives).

In its simplest form, the invention comprises components to be utilized in the mechanics of a document scanner wherein the component's properties allow for optimized calibration of the scanner while enabling elimination of ghosting, or reverse side reflection from a double-sided document. Depending upon the type of scanner, the inventive method may comprise a black backing on the scanner lid combined with calibration strips (flat bed scanner), or a dual colored rotating cylinder or mechanism (sheet fed or duplex scanners), or series thereof.

In a traditional scan, a calibration function is customarily performed prior to each scan. This is presently done utilizing a pixel scheme wherein the reflective light's red, green, and blue components are measured for each pixel location and adjusted to a defined reference standard. Such measurement is performed without the lamp or light source activated to retrieve the dark response for each pixel, and with the light source activated to effect a white reference source. The two methods combined form the calibration of each pixel in the scanning device, and in essence, create an artificial black and white reference. The accuracy of the calibration scheme can be greatly improved by providing actual black and white references for calibration rather than the alternating light method. As such, both a white and a black reflective target are required.

### THE INVENTION

### SUMMARY, OBJECTS AND ADVANTAGES

In order to calibrate a scanner, both a black and white reference is required. Present industry standards offer scanners which have a white or light colored backing which associates with the medium to be scanned. In the case of such a backing, a document that consists of two sides containing images, a light colored backing allows reflectivity that can result in a portion of the reverse side of the document to manifest on the resultant scan. A strictly white background allows reflectivity of the document being scanned as the light travels through the medium and reflects off a white backing. In the case of a two-sided document, especially wherein the back side is darker than that desired to be scanned, a white background allows ghosting of the reverse side image, ultimately manifesting itself as a defect on a scanned image. The inventive method provides for a dark or alternating dark/light background so that reflection is not an optical issue resulting in the ghosting of a reverse side image.

Since calibration is required of any standard document scanner using a light source, such calibration cannot be performed against only a black background. Both a black and white reference are required. In current technologies, the scanner's light source needs to be alternated in illumination to create the effect of a dark and light reference. In other words, the scanner lamp illuminated represents the white reference, and then the lamp is switched off to represent a black reference. The inventive method provides a unique solution to the problem of ghosting while allowing an optimized means for calibration. By utilizing a solution of an alternating black and white backing in the case of sheet fed scanners, and calibration strips combined with a black backing on a flat bed scanner, the inventive method offers a simple, yet effective solution wherein the scanner's lamp is not the driving force behind the black and white references.

Pursuant to a flat bed scanner, an ideal embodiment of the present invention includes a sheet of black material as the backing on the insert of the scanner lid or cover. At the onset of the platen, two calibration strips are placed to effect a white response detector, and a black response detector. Commensurate with the scan, the calibration strips perform the calibration utilizing standard black and white detection, whereas the black backing on the scanner cover precludes reflection of the document's reverse side, and eliminates a ghosting defect on the resultant scan.

In the case of a sheet fed scanner, an ideal embodiment of the present invention may include a cylindrical shaped tube or roll wherein half of the tube or roll is black, and the other half is white so as to create the necessary pixel arrays. The cylinder can be manufactured of plastic, hard form paper product, or a myriad of alternate materials as would be logical in relation to the housing and additional components of a particular scanner. The cylinder would be installed under the platen in a manner such that the scanner's light source can reflect on the cylinder detecting whether the cylinder surface is black or white. In this example, the cylinder may be controlled by an electromechanical switch enabling rotation from the black side to the white side for alternate scanner calibration, and provision of a black background sufficient to eliminate ghosting. In the case of a duplex scanner, two sets of pixel arrays are used, one for the top and one for the bottom.

Various embodiments of the inventive method may be employed depending upon the type of document scanner utilized, but the basic design and functionality of the mechanics is the same. Wherein the case of the flatbed scanner, the embodiment illustrated in FIG. 1 may be utilized. In the case of a sheet fed scanner, the embodiment illustrated in FIG. 2 may be utilized. The number and placement of black and white colored cylinders can be altered depending on the scanner type, light source configuration, and type of light the scanner utilizes. The inventive method is not improved upon by placement of additional cylinders or backing. Placement design thereof simply correlates to the type of scanner or hardware to be utilized.

### BRIEF DESCRIPTION OF THE DRAWINGS

The invention is described in further detail by reference to the drawings in which:

FIG. 1 is an illustration of a flatbed scanner configuration wherein black backing and calibration strips achieves the inventive method; and

FIG. 2 is an illustration of a sheet fed scanner configuration wherein an alternatively black and white cylinder achieves the inventive method; and

FIG. 3; is a flowchart depicting the functional steps related to the inventive method in order of performance.

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in three relatively simple figures; although sufficiently complex as to illuminate to one skilled in the art of such scanner architecture, and calibration methods viable for making or using said invention.

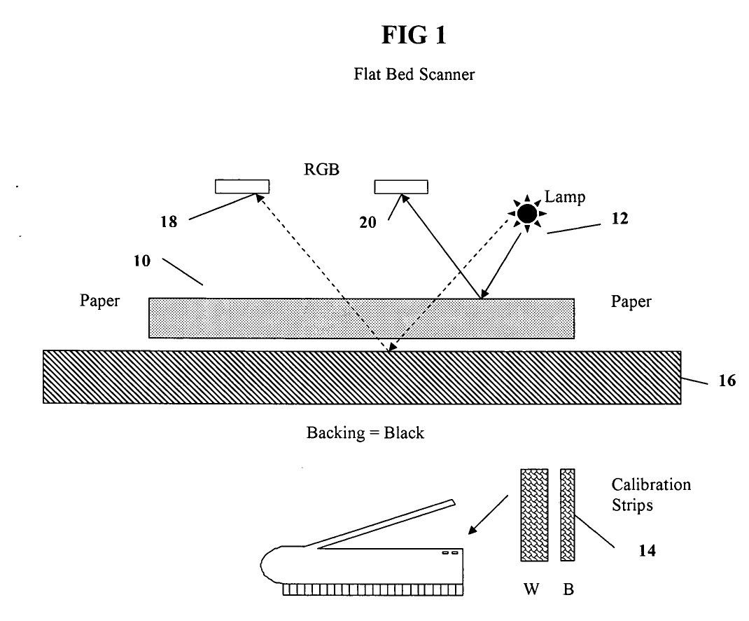

FIG. 1 illustrates the inventive method as placed in a flatbed type scanner. A medium or color target is placed on the scanner's platen 10 so as to offer an objective for performing calibration and subsequent scan. The lamp or light source 12 as relevant to the scanner type is initiated and causes light reflection. Calibration strips 14 consisting of one black and one white in color are located at the initiation point of the scan, and calibration occurs as with industry standard practice. Such calibration strips allow color target comparison and subsequent calibration in the standard manner known in the art.

Further to FIG. 1, a black backing 16 is situated on the scanner, typically the lid or top of the scanner. After said calibration, the light emanating from the lamp 12 is able to illuminate only the top side of the intended scan target document. In the case of a white or light colored backing, the light path would in essence shine through the target to be scanned 18, and thus would reflect a reverse side ghost image artifact on the resultant scan. This is the case wherein a double sided document or target is placed to be scanned, and especially wherein said document or target has a darker reverse side than the one desired to be scanned.

In FIG. 1, considering the same elements as in the light path above, light travels to the medium to be scanned 10 and is localized on the front side of the medium. The light is allowed interaction between the RGB and source and the medium top side of the medium itself without allowing through reflection which would transfer reverse side artifacts to the final scan 20.

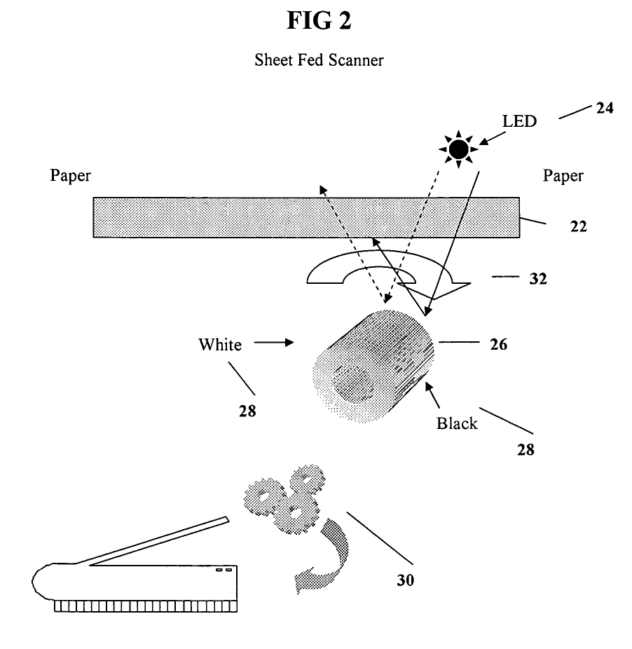

FIG. 2 illustrates an example of the inventive method being achieved in a sheet fed type scanner. Different to FIG. 1, the target 22 is inserted via an ADF or automatic document feeder. Similar in function to FIG. 1, the lamp or LED 24 is initiated and emits light upon the target to be scanned. At this stage, calibration must occur. In the present art, calibration would occur based upon the process of alternating the light source to create artificial black and white references. In the inventive method, a cylindrical shaped device 26 is incorporated into the scanner mechanics.

Further to FIG. 2, said cylinder, which may be constructed of materials of the manufacturer's choosing, is dual colored—half black and half white 28. An electromechanical switch or switches 30 may be utilized to effect rotation of the cylinder. In the ideal embodiment, the cylinder begins in the white position and calibration occurs using the white reference. After white calibration, the switch 30 causes rotation 32 of the cylinder from the white half to the black half and calibration using the black reference is completed. The scan then proceeds with the cylinder remaining in the black position to effect a scan without allowing reflectivity of the reverse side of the medium, i.e. ghosting.

As with both FIGS. 1 and 2, the black backing, whether on the flatbed example, or the cylinders in the sheet fed example, allows for a single side of the scan target to be illuminated without reflection from the reverse side. In the sheet fed example, the alternating cylinder serves to provide an improved method of calibration wherein a scanner's lamp need not be alternated to create an artificial black and white reference set. The resulting scan in either configuration will demonstrate no ghosting artifacts in the final scanned image.

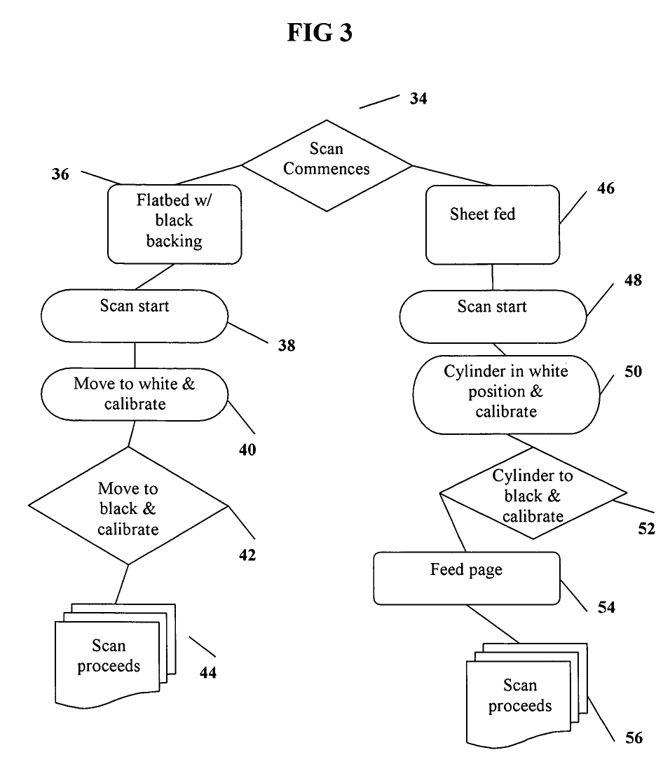

FIG. 3 is a simple diagrammatic representation of the flow of steps inherent to the inventive process. In both example as illustrated in FIGS. 1 and 2, a scan is initiated 34. In the case of a flatbed scanner 36, a black backing is present on the underside lid of the scanner. Scan start is initiated 38, and calibration occurs using the white calibration reference as provided by the white calibration strip 40 located at the onset of the scanner platen. Calibration then occurs using the black reference strip 42. In this simple process, once calibration is complete, a subsequent scan is conducted in a straightforward manner 44 wherein the process now has the benefit of a black, non-reflective backing.

In the case of a sheet fed scanner 46, scan start is activated 48. The cylinder resides or is moved to the white position 50 to calibrate from the white reference point. The switch engages and rotates the cylinder to its black position 52 and calibration completes using the black reference point. At this point, the cylinder remains in the black position for scanning, and a feed page function occurs 54. The scan proceeds, taking advantage of the black backing provided by the cylinder as retained in the black position post calibration 56.

In all embodiments detailed herein, the inventive method is simple, yet eliminates a common problem with dual sided documents or media to be scanned. While the embodiments detailed herein are considered the best mode by the inventor, there are certainly variations which could be used in terms of materials, but such variations do not enhance or alter the functional process. Alternate placement of the colored cylinders in the sheet fed scanner examples will also not enhance the performance or mechanical function of the inventive method, but will be dictated by the style of manufacture of the particular scanner in which the inventive method may be installed.

1) A method for elimination of ghosting or reverse side reflection resulting in defects in a scanned document, comprising:
a) means for providing suitable colored backing within a scanner's physical housing;
b) means for providing alternating colored mechanisms within a scanner's physical housing;
c) means for improved calibration of a sheet fed or duplex scanner.

2) A method as in claim 1 wherein said suitable colored backing is a black or non-reflective material affixed to the underside lid or cover of a flatbed scanner to provide a non-reflective surface.

3) A method as in claim 2 wherein said colored backing may be manufactured of a paper product or other suitable composition such as to create a sufficiently dark background to provide said non-reflective surface as affixed to said underside scanner lid.

4) A method as in claim 1 wherein said alternating colored mechanisms are comprised of cylinder shaped devices situated within the scanner housing which may be rotated in order to provide said alternating colors in the form of a black and white source.

5) A method as in claim 4 wherein said means comprise devices which may be crafted from plastic or other suitable materials of manufacture, and wherein said devices may alternately be shaped in any manner that allows said alternating colors to be switched from one side to the opposing side.

6) A method as in claim 4 wherein said devices are bi-tonal in hue meaning one half black and one half white wherein the black half of the device provides a black reference for scanner calibration and to effect said sufficiently dark background for non-reflectivity of a dual sided medium to be scanned.

7) A method as in claim 6 wherein said devices are bi-tonal in hue wherein the white half of the device provides a white source for said proper calibration of a scanner.

8) A method as in claim 4 wherein the means for providing alternating colored mechanisms for presentation to a scanner's light source is effected by mechanical or electromechanical switches for achieving rotation of said mechanism.

9) A method as in claim 8 wherein said switches provide the ability to cause said alternating colored mechanisms to rotate from one side to the opposing side.

10) A method as in claim 1 wherein said calibration is improved by the elimination of dependence on the scanner's light source itself as a means for creating an artificial black and white source for calibration in the instance of a sheet fed or duplex type scanner.

11) The method of claim 10 wherein the presence of an actual black and white reference on said colored mechanisms effects said improved calibration by eliminating the need for a scanner's light source to turn on, calibrate, turn off and further calibrate.
